(19) United States
(12) Patent Application Publication
(10) Pub. No.: US 2019/0305637 A1
(43) Pub. Date: Oct. 3, 2019

(54) VIBRATION GENERATING DEVICE

(71) Applicant: ALPS ALPINE CO., LTD., Tokyo (JP)

(72) Inventors: Katsutoshi SUZUKI, Miyagi (JP); Takashi NAKASHIMA, Miyagi (JP); Shinobu ABE, Miyagi (JP)

(21) Appl. No.: 16/447,099

(22) Filed: Jun. 20, 2019

Related U.S. Application Data
(63) Continuation of application No. PCT/JP2017/045809, filed on Dec. 20, 2017.

(30) Foreign Application Priority Data
Dec. 22, 2016 (JP) 2016-250097

(51) Int. Cl. H02K 7/06; H02K 7/065; H02K 7/14

(52) U.S. Cl. CPC H02K 7/063; B06B 1/04; H02K 7/14; H02K 7/065

(57) ABSTRACT

A vibration generating device includes at least one coil fixed to a casing, a magnet holder disposed in the casing, a permanent magnet attached to the magnet holder, the permanent magnet and the magnet holder being configured to vibrate when a current flows into the coil, a plurality of elastic supporting sections configured to support the magnet holder, a plurality of weights formed of material including tungsten, and a plurality of attachment sections configured to hold the respective weights and be attached to the magnet holder.

### CROSS-REFERENCE TO RELATED APPLICATION

This application is a continuation application of International Application No. PCT/JP2017/045809 filed on Dec. 20, 2017, and designated the U.S., which is based upon and claims priority to Japanese Patent Application No. 2016-250097, filed on Dec. 22, 2016, the entire contents of which are incorporated herein by reference.

### BACKGROUND OF THE INVENTION

### 1. Field of the Invention

The present disclosure relates to a vibration generating device.

### 2. Description of the Related Art

For mobile electronic equipment such as a mobile phone or a game machine, a vibration generating device is employed to inform a user of a call with vibrations or apply tactile stimulus to a user according to a game situation. Such a vibration generating device is employed in the mobile electronic equipment, and is required to be downsized. As an example of such a vibration generating device, Japanese Unexamined Patent Application Publication No. 2015-44177 (Patent Document 1) discloses a vibration generating device for generating a vibration. In the vibration generating device, springs are disposed at opposite sides of a weight into which a permanent magnet is inserted, and a coil is situated opposite to the permanent magnet. When a current flows into the coil, the weight sandwiched between the springs vibrates, thereby generating vibration.

### SUMMARY OF THE INVENTION

In one aspect according to embodiments, a vibration generating device includes at least one coil fixed to a casing, a magnet holder disposed in the casing, a permanent magnet attached to the magnet holder, the permanent magnet and the magnet holder being configured to vibrate when a current flows into the coil, a plurality of elastic supporting sections configured to support the magnet holder, a plurality of weights formed of material including tungsten, and a plurality of attachment sections configured to hold the respective weights and be attached to the magnet holder.

### BRIEF DESCRIPTION OF THE DRAWINGS

Other objects and further features of embodiments will become apparent from the following detailed description when read in conjunction with the accompanying drawings, in which:

FIG. 1 is an exploded perspective view illustrating an example of a downsized vibration generating device;

FIG. 2 is a perspective view illustrating an example of an internal configuration of the downsized vibration generating device;

FIG. 3 is an exploded perspective view illustrating an example of a vibration generating device according to a first embodiment;

FIG. 4 is a perspective view illustrating an example of an internal configuration of the vibration generating device according to the first embodiment;

FIG. 5 is a top view illustrating an example of the internal configuration of the vibration generating device according to the first embodiment;

FIG. 6 is a diagram (1) for explaining the vibration generating device according to the first embodiment;

FIG. 7 is a diagram (2) for explaining the vibration generating device according to the first embodiment;

FIG. 8 is an exploded perspective view illustrating an example of a vibration generating device according to a second embodiment;

FIG. 9 is an exploded perspective view illustrating an example of a vibration generating device according to a third embodiment;

FIG. 10 is a perspective view illustrating an example of an internal configuration of the vibration generating device according to the third embodiment;

FIG. 11 is a top view illustrating an example of the internal configuration of the vibration generating device according to the third embodiment;

FIG. 12 is a diagram (1) for explaining the vibration generating device according to the third embodiment;

FIG. 13 is a diagram (2) for explaining the vibration generating device according to the third embodiment; and

FIG. 14 is a diagram (3) for explaining the vibration generating device according to the third embodiment.

### DESCRIPTION OF THE PREFERRED EMBODIMENTS

Embodiments will be explained hereinafter with reference to the drawings. Note that the same reference numerals are used to denote same components or the like in each drawing; accordingly, for the same components or the like, explanation may be omitted. In the following description, an X1-X2 direction, a Y1-Y2 direction and a Z1-Z2 direction are mutually perpendicular. A plane including the X1-X2 direction and the Y1-Y2 direction refers to an X-Y plane, a plane including the Y1-Y2 direction and the Z1-Z2 direction refers to a Y-Z plane, and a plane including the Z1-Z2 direction and the X1-X2 direction refers to a Z-X plane.

For the vibration generating device disclosed in Patent Document 1, the inventors have recognized the following: the vibration generating device is employed in electronics equipment, and is required to be downsized. Under the above situation, if a small-size weight is formed of stainless steel that can be easily processed, as in the case of a commercially available weight, the weight is lightened because specific weight of stainless steel is not so great. However, with respect to such a lightened weight, vibrations are decreased, and as a result, a function of the vibration generating device may be declined. In order to increase vibrations, a weight may be formed of material having a large specific weight, e.g., tungsten, so as to be heavier. However, because tungsten has a high melting point and is a hard metal, a tungsten weight is not able to be easily processed to form an opening into which a permanent magnet is inserted. For these reasons, a downsized vibration generating device cannot be easily manufactured.

In view of the above, the inventors have recognized that a vibration generating device whose size is decreased and that is capable of being easily manufactured is required.

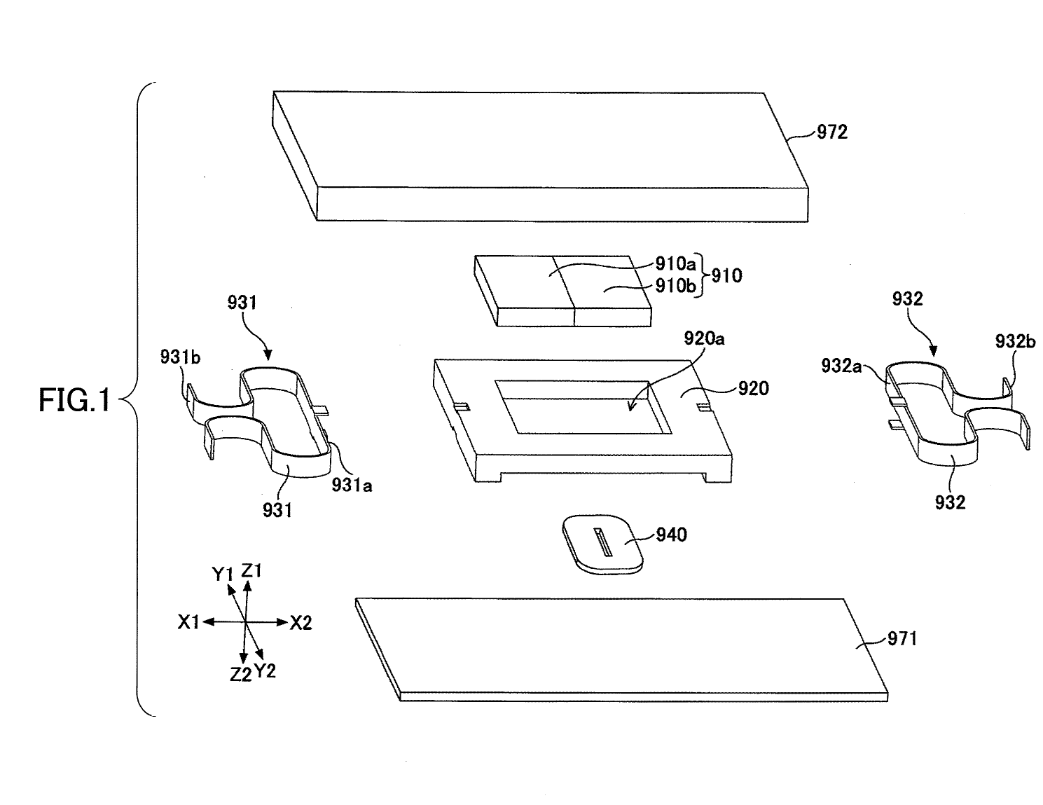

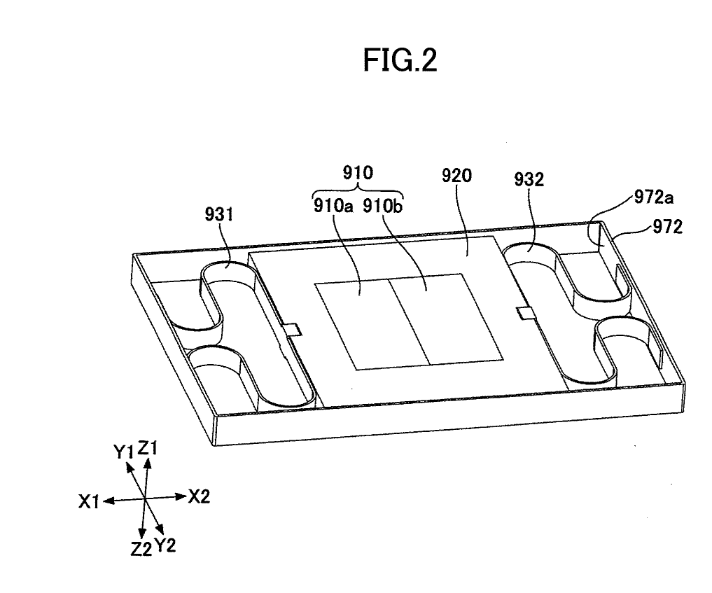

Hereafter, a downsized vibration generating device is described in detail with reference to FIGS. 1 and 2. FIG. 1 is an exploded perspective view illustrating this vibration generating device. FIG. 2 is a perspective view illustrating an internal configuration of the vibration generating device from which a cover section thereof is partially removed. This vibration generating device includes a permanent magnet 910, a magnet holder 920, a first spring section 931, a second spring section 932, a coil 940 and the like, and these components are encased in a casing that is formed by a base section 971 and a cover section 972. The permanent magnet 910 is formed in a flat, approximate rectangular shape. The permanent magnet 910 includes one pole 910a and another pole 910b. For example, the pole 910a is an N pole, and the pole 910b is an S pole.

The permanent magnet 910 is inserted into an opening 920a provided through the magnet holder 920. The magnet holder 920 has an approximate rectangular shape. The first spring section 931 and the second spring section 932 are attached to the respective opposite sides of the magnet holder 920. Specifically, a first side portion 931a of the first spring section 931 is attached to one side of the magnet holder 920, and further, a first side portion 932a of the second spring section 932 is attached to the other side of the magnet holder 920. Also, second side portions 931b of the first spring section 931 and second side portions 932b of the second spring section 932 are each connected to an inner wall surface 972a of the cover section 972. At a location of the base section 971 above which the permanent magnet 910 is situated, the flat coil 940 is attached with an adhesive. When a current flows into the coil 940, the magnet holder 920, into which the permanent magnet 910 is inserted, sandwiched between the first spring section 931 and the second spring section 932 can vibrate.

As described above, in a case of downsizing a vibration generating device, sizes of all components are decreased. As a result, the size of the magnet holder 920 is decreased as well, and thus the magnet holder 920 is lightened. With respect to such a lightened magnet holder 920, vibrations from the magnet holder 920 are not powerful, and might not be perceived by a user. As a manner of generating powerful vibrations perceivable by a user, a case where a magnet holder 920 is formed of a large specific weight material such as tungsten (W) is considered. However, because tungsten has a high melting point and is a hard metal, a tungsten magnet holder 920 cannot be easily processed in machine processing or welding to form an opening 920a shaped as desired. Also, in a case where a sintered compact shaped as desired is produced with use of a powdered material, although an opening of the sintered compact is shaped as desired, productivity is relatively low, and the accuracy of dimension may not be always precise. Further, with respect to such a sintered compact or an alloy of tungsten of which the productivity is increased, the specific weight is lower than pure tungsten. Under the situation as recognized by the inventors, they have embodied the following embodiments.

### First Embodiment

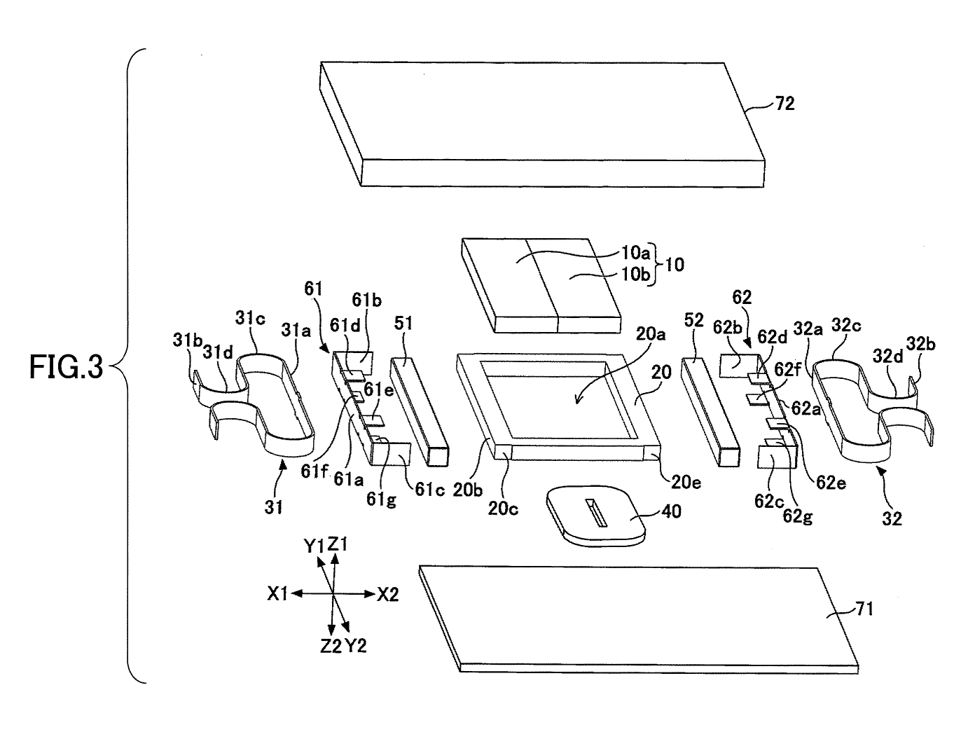

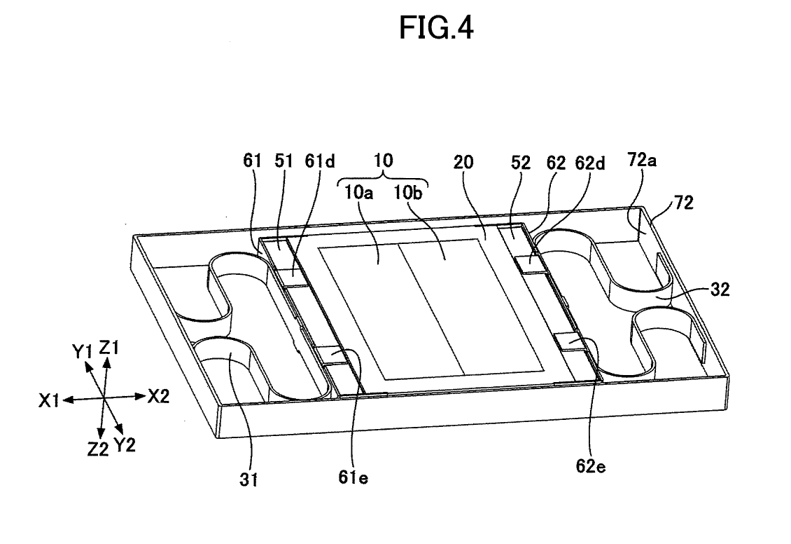

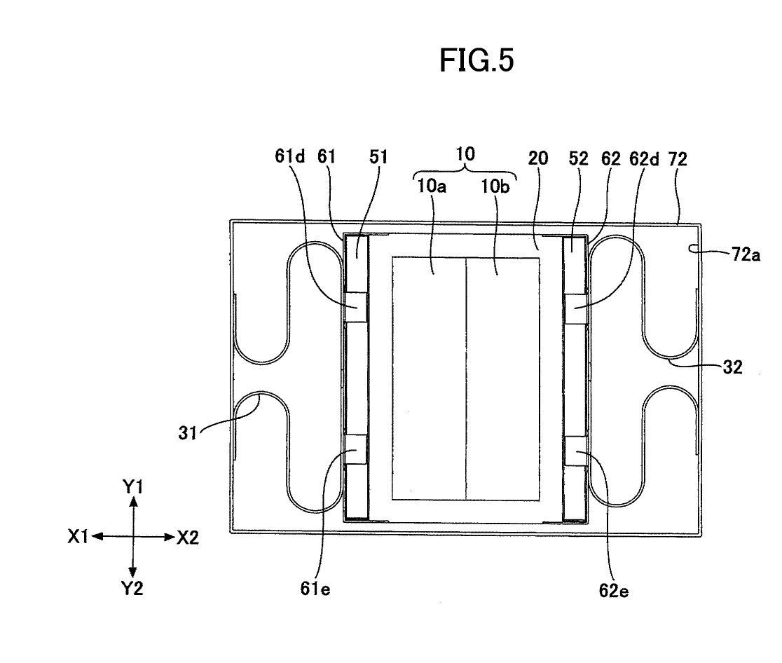

Hereafter, a vibration generating device according to a first embodiment is described in detail with reference to FIGS. 3 to 5. FIG. 3 is an exploded perspective view illustrating a vibration generating device according to the present embodiment. FIG. 4 is a perspective view of an internal configuration of the vibration generating device according to the present embodiment from which a cover section of the vibration generating device is partially removed. FIG. 5 is a top view of FIG. 4. This vibration generating device includes a permanent magnet 10, a magnet holder 20, a first spring section 31, a second spring section 32, a coil 40, a first weight 51, a second weight 52, a first attachment section 61, a second attachment section 62, and the like. These components are encased in a casing that is famed by a base section 71 and a cover section 72. In the following description, the first spring section 31 may also be referred to as a first supporting section, and the second spring section 32 may also be referred to as a second supporting section.

The permanent magnet 10 is flat along a plane parallel to an X-Y plane, and is formed in an approximate rectangular shape. The permanent magnet 10 includes one pole 10a and another pole 10b. As an example, the pole 10a is an N pole, and the pole 10b is an S pole. The permanent magnet 10 is inserted into an opening 20a provided through the magnet holder 20 such that the pole 10a is situated on an X1 direction side and the pole 10b is situated on an X2 direction side. The magnet holder 20 is formed so as to have an approximate rectangular shape. On the X1 direction side being a first side of the magnet holder 20, the first attachment section 61 into which the first weight 51 is attached is mounted. Also, on the X2 direction side being a second side of the magnet holder 20, the second attachment section 62 into which the second weight 52 is attached is mounted.

Also, a first side portion 31a of the first spring section 31 is connected to an X1 direction side of the first attachment section 61 being an outer side of the first attachment section 61. Second side portions 31b of the first spring section 31 are each connected to an inner wall surface 72a of the cover section 72. In such a manner, the first spring section 31 is sandwiched between the first attachment section 61 and the inner wall surface 72a of the cover section 72. A first side portion 32a of the second spring section 32 is connected to an X2 direction side of the second attachment section 62 being an outer side of the second attachment section 62. Second side portions 32b of the second spring section 32 are each connected on the inner wall surface 72a of the cover section 72. In such a manner, the second spring section 32 is sandwiched between the second attachment section 62 and the inner wall surface 72a of the cover section 72.

In such a configuration, the magnet holder 20 into which the permanent magnet 10 is inserted, as well as the first weight 51, the first attachment section 61, the second weight 52 and the second attachment section 62 that are attached to the magnet holder 20, are integrated. These integrated components are sandwiched between the first spring section 31 and the second spring section 32, and thus are positioned floatingly. The flat coil 40 along a plane parallel to the X-Y plane is attached to the base section 71 with an adhesive, such that the coil 40 is situated opposite to the permanent magnet 10 and such that a longitudinal direction of the coil 40 is the Y1-Y2 direction. In the present embodiment, when a current flows into the coil 40, there is an interaction between a produced magnetic field and a magnetic force acting between the pole 10a and the pole 10b of the permanent magnet 10. The interaction can cause the permanent magnet 10 to move in the X1-X2 direction.

Note that in the present embodiment, the magnet holder 20, the first spring section 31, the second spring section 32, the first attachment section 61, the second attachment section 62, and the like are formed of stainless steel capable of being easily processed. For this reason, in forming the magnet holder 20, the opening 20a can be easily shaped as desired. Also, the magnet holder 20, the first spring section 31, the second spring section 32, the first weight 51, the second weight 52, the first attachment section 61 and the second attachment section 62 are each formed of non-magnetic material.

The first spring section 31 and the second spring section 32 are each formed by bending a stainless steel plate. With respect to the first spring section 31, first curvature sections 31c and second curvature sections 31d are formed between the first side portion 31a and the second side portions 31b. These first and second curvature sections 31c and 31d are formed, so that the first spring section 31 is elastic in the X1-X2 direction. Also, with respect to the second spring section 32, first curvature sections 32c and second curvature sections 32d are formed between the first side portion 32a and the second side portions 32b. These first and second curvature sections 32c and 32d are formed, so that the second spring section 32 is elastic in the X1-X2 direction. A driving force in the X1-X2 direction acting with use of the coil 40 and the permanent magnet 10, as well as an elastic force in the X1-X2 direction acting with use of the first spring section 31 and the second spring section 32, can cause the integrated components, which include the permanent magnet 10, the magnet holder 20, the first weight 51, the first attachment section 61, the second weight 52 and the second attachment section 62, to move in the X1-X2 direction.

The first weight 51 and the second weight 52 are each formed of a tungsten member whose shape is an approximate quadrangular prism. Tungsten has a specific gravity of 19.3 g/cm³ at a temperature of 20° C., and this specific gravity is greater than double that of stainless steel ranging from 7.5 g/cm³ to 7.9 g/cm³. For this reason, even if each of the first weight 51 and the second weight 52 is relatively small, the weights are relatively heavy. In such a manner, even in a case where a vibration generating device is downsized, powerful vibrations are generated as suited. The first weight 51 and the second weight 52 may be each formed of sintered tungsten, or be each formed of pure tungsten. Sintered tungsten has specific gravity ranging from 17 g/cm³ to 18.5 g/cm³. In this regard, specific gravity of pure tungsten is greater than that of sintered tungsten described above. For this reason, for a pure tungsten weight and a sintered tungsten weight formed with a same volume, the pure tungsten weight is heavier than the sintered tungsten weight. In light of the above point, the first weight 51 and the second weight 52 may be each formed of tungsten whose specific gravity is 19 g/cm³ or more. In the present embodiment, each of the first weight 51 and the second weight 52 is formed in an approximate quadrangular shape whose bottom face has an approximate square shape of about 1.8 mm per side. Note that each of the first weight 51 and the second weight 52 may have a circular cylinder shape, or be formed of multiple tungsten members. Each of the first weight 51 and the second weight 52 may have a quadrangular shape that can be arranged closely in a predetermined area.

In the present embodiment, each of the first weight 51 and the second weight 52 is formed such that the size thereof in the Z1-Z2 direction is larger than that of a portion of the magnet holder 20 opposite the coil 40. In such a manner, even if a thin magnet holder 20 is formed so as not to interfere with the coil 40, each of the first weight 51 and the second weight 52 can have proper size and mass, and thus powerful vibrations are generated as suited.

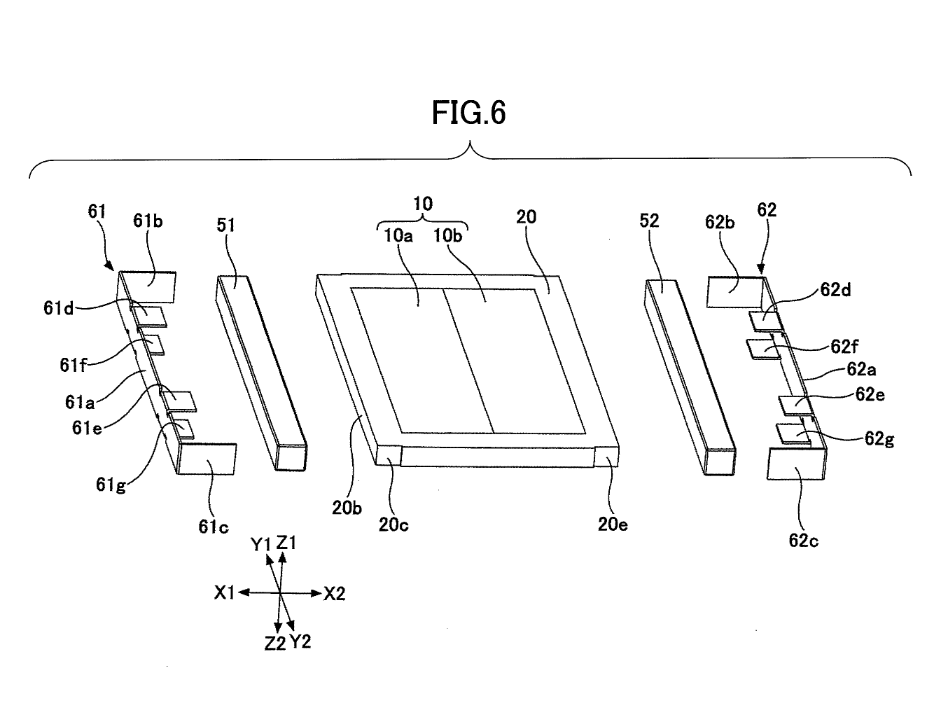

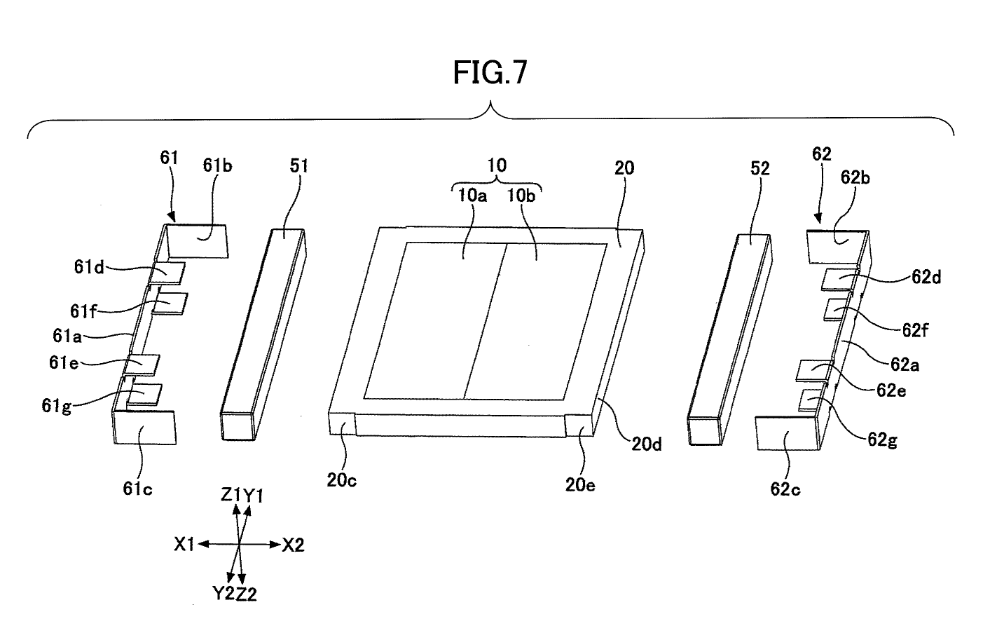

Hereafter, with reference to FIGS. 6 and 7, the first attachment section 61 for attaching the first weight 51 as well as the second attachment section 62 for attaching the second weight 52 are described. Each of the first attachment section 61 and the second attachment section 62 is formed by bending a stainless steel plate. In the present embodiment, each of the first attachment section 61 and the second attachment section 62 is formed by bending a stainless steel plate whose thickness is about 0.3 mm. FIGS. 6 and 7 are perspective views for explaining the first weight 51, the second weight 52, the first attachment section 61 and the second attachment section 62. FIG. 6 is a perspective view of components in a case of being viewed from a side of the first attachment section 61. FIG. 7 is a perspective view of components in a case of being viewed from a side of the second attachment section 62. The permanent magnet 10 is fixed with an adhesive in a manner in which the permanent magnet 10 is inserted into the opening 20a of the magnet holder 20.

In the first attachment section 61, a spring connecting section 61a whose longitudinal direction is the Y1-Y2 direction, holder-connecting sections 61b and 61c, weight-supporting sections 61d and 61e, and weight-supporting sections 61f and 61g are formed. The holder-connecting sections 61b and 61c, which are respective opposite sides of the spring connecting section 61a along the Y1-Y2 direction being the longitudinal direction of the spring connecting section 61a, are bent in an approximate orthogonal direction toward the X2 direction. The weight-supporting sections 61d and 61e, which are respective two portions of the spring connecting section 61a toward a Z1 direction side in a short direction of the spring connecting section 61a, are bent in an approximate orthogonal direction toward the X2 direction. The weight-supporting sections 61f and 61g, which are respective two portions of the spring connecting section 61a toward a Z2 direction side in the short direction of the spring connecting section 61a, are bent in an approximate orthogonal direction toward the X2 direction.

Similarly, in the second attachment section 62, a spring connecting section 62a whose longitudinal direction is the Y1-Y2 direction, holder-connecting sections 62b and 62c, weight-supporting sections 62d and 62e, and weight-supporting sections 62f and 62g are formed. The holder-connecting sections 62b and 62c, which are respective opposite sides of the spring connecting section 62a along the Y1-Y2 direction being the longitudinal direction of the spring connecting section 62a, are bent in an approximate orthogonal direction toward the X1 direction. The weight-supporting sections 62d and 62e, which are respective two portions of the spring connecting section 62a toward a Z1 direction side in a short direction of the spring connecting section 62a, are bent in an approximate orthogonal direction toward the X1 direction. The weight-supporting sections 62f and 62g, which are respective two portions of the spring connecting section 62a toward a Z2 direction side in the short direction of the spring connecting section 62a, are bent in an approximate orthogonal direction toward the X1 direction.

In the present embodiment, the first weight 51 is attached to the magnet holder 20 with use of the first attachment section 61. The second weight 52 is attached to the magnet holder 20 with use of the second attachment section 62.

Specifically, the first weight 51 is attached to the first attachment section 61 such that a surface of the spring connecting section 61a facing the X2 direction is opposite to a side surface of the first weight 51 facing an X1 direction along the longitudinal direction of the first weight 51. In this case, the first weight 51 is partially surrounded by the spring connecting section 61a, the holder-connecting sections 61b and 61c, and the weight-supporting sections 61d, 61e, 61f and 61g of the first attachment section 61. An inner portion of the plate section 161a of the first attachment section 61 is attached to one side surface 20b of the magnet holder 20, which is parallel to the Y-Z plane on an X1 direction side, through the first weight 51. The holder-connecting sections 61b and 61c of the first attachment section 61 are joined to the magnet holder 20 by spot welding. As an example, the holder-connecting sections 61b and 61c of the first attachment section 61 are joined to the respective end sections 20c of the magnet holder 20, which is parallel to the Z-X plane. The first weight 51 may be fitted to at least one of an inner surface of the first attachment section 61 or the side surface 20b of the magnet holder 20, with an adhesive. Thereby, a noise during vibrating due to a minute gap can be prevented.

The second weight 52 is attached to the second attachment section 62 such that a surface of the spring connecting section 62a facing the X1 direction is opposite to a side surface of the second weight 52 facing an X2 direction along the longitudinal direction of the second weight 51. In this case, the second weight 52 is partially surrounded by the spring connecting section 62a, the holder-connecting sections 62b and 62c, and the weight-supporting sections 62d, 62e, 62f and 62g of the second attachment section 62. An inner portion of the spring connecting section 62a of the second attachment section 62 is attached to one side surface 20d of the magnet holder 20, which is parallel to the Y-Z plane on an X2 direction side, through the second weight 52. The holder-connecting sections 62b and 62c of the second attachment section 62 are joined to the magnet holder 20 by spot welding. As an example, the holder-connecting sections 62b and 62c of the second attachment section 62 are joined to the respective end sections 20e of the magnet holder 20, which are parallel to the Z-X plane. The second weight 52 may be fitted to at least one of an inner surface of the second attachment section 62 or the side surface 20d of the magnet holder 20, with an adhesive. Thereby, a noise during vibrating due to a minute gap can be prevented.

As illustrated in FIGS. 3 to 5, the first side portion 31a of the first spring section 31 is connected to an outer surface of the spring connecting section 61a of the first attachment section 61 toward the X1 direction, by spot welding. Further, the second side portions 31b of the first spring section 31 are each connected to the inner wall surface 72a of the cover section 72 toward the X1 direction, by spot welding. Similarly, the second side portion 32a of the second spring section 32 is connected to an outer surface of the spring connecting section 62a of the second attachment section 62 toward the X2 direction, by spot welding. Further, the second side portions 32b of the second spring section 32 are each connected to the inner wall surface 72a of the cover section 72 toward the X2 direction, by spot welding.

The vibration generating device according to the present embodiment can vibrate in the X1-X2 direction when a current flows into the coil 40. The first spring section 31 and the second spring section 32 are attached to the respective opposite sides along the X1-X2 direction being a vibration direction of the vibration generating device. Also, the first weight 51 is attached using the first attachment section 61, between the magnet holder 20 and the first spring section 31. The second weight 52 is attached using the second attachment section 62, between the magnet holder 20 and the second spring section 32. In such an attachment, the first weight 51 and the second weight 52 can be each attached so as to be pressed into the magnet holder 20 along the vibration direction. During vibrating, this can decrease a force along a direction in which first welding portions with respect to the first attachment section 61, the second attachment section 62 and the magnet holder 20 and second welding portions with respect to the first attachment section 61, the first spring section 31, the second attachment section 62 and the second spring section 32 would move away from each other.

In the present embodiment, total mass (weight) of the magnet holder 20, the first attachment section 61, the second attachment section 62, the first weight 51 and the second weight 52, which are sandwiched between the first spring section 31 and the second spring section 32, is greater than total mass (weight) in a case where the components described above are formed of stainless steel only. In such a manner, even if a vibration generating device is downsized, powerful vibrations can be generated as suited.

In the present embodiment, mass of the magnet holder 20 is 660 mg, mass of each of the first attachment section 61 and the second attachment section 62 is 135 mg, and mass of each of the first weight 51 and the second weight 52 is 550 mg. Total mass of the first attachment section 61 and the first weight 51 is 685 mg. In a case where, without using the first weight 51 and the first attachment section 61, a component having a same volume as the first weight 51 and the first attachment section 61 is formed of stainless steel and is formed integrally with a magnet holder 20, total mass of such an integrated magnet holder 20 is merely increased by less than 370 mg, compared to the magnet holder 20 in the present embodiment. According to the present embodiment, with respect to either of components 51 and 61 or components 52 and 62, they can increase 300 mg or more in mass. With respect to both of the first weight 51 and the second weight 52, they can increase 600 mg. The effect of increasing mass of the first weight 51 greatly depends upon volume of the first weight 51 that is made available to a space of the first attachment section 61 and the first weight 51. In light of the above, each of the first attachment section 61 and the second attachment section 62 may be thin to some extent that its strength is proper, in consideration of the assembly.

Also, total weight of the magnet holder 20, the first attachment section 61, the second attachment section 62, the first weight 51 and the second weight 52, which are sandwiched between the first spring section 31 and the second spring section 32, is 2030 mg. In this example, total mass of the first weight 51 and the second weight 52 that are both formed of tungsten is 1100 mg. This is greater than 930 mg that is total weight of the magnet holder 20, the first attachment section 61 and the second attachment section 62.

As described above, in the present embodiment, total mass of the first weight 51 and the second weight 52 is greater than total mass of the magnet holder 20, the first attachment section 61 and the second attachment section 62. In such a manner, mass of components sandwiched between the first spring section 31 and the second spring section 32 is increased, and thus powerful vibrations are generated as suited.

### Second Embodiment

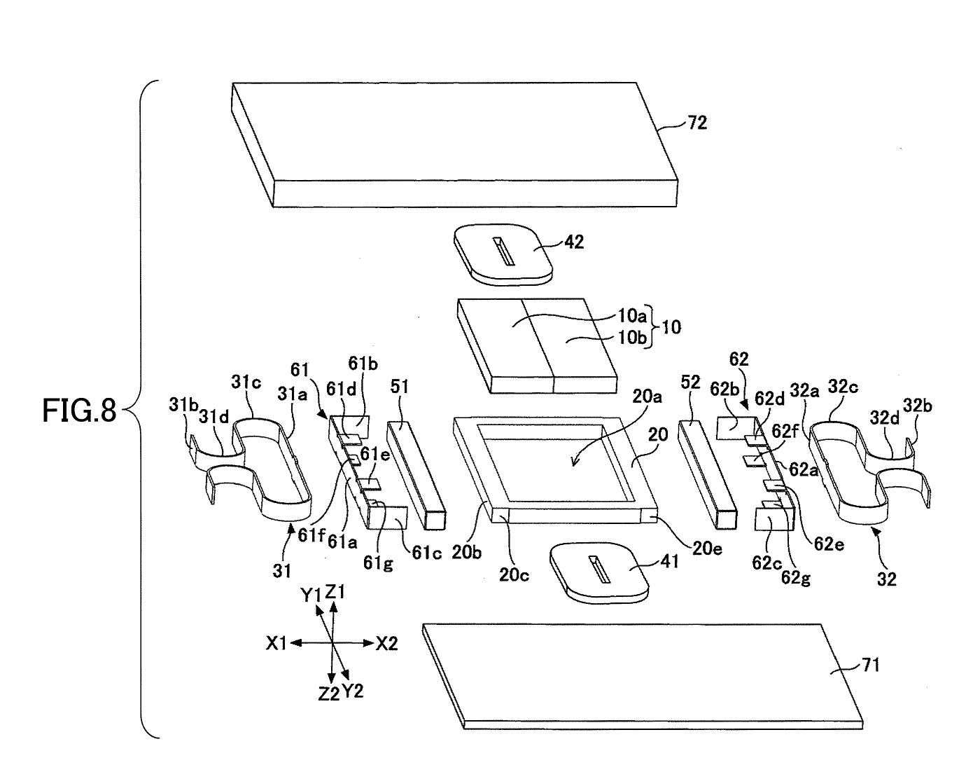

Hereafter, a second embodiment is described. In the present embodiment, a vibration generating device includes coils disposed on the respective opposite surfaces of a permanent magnet 10, as illustrated in FIG. 8. In this example, a first coil 41 is mounted at a location of a base section 71 with an adhesive, so as to be opposite to the permanent magnet 10. A second coil 42 is mounted on an inner surface of a cover section 72 with an adhesive, so as to be opposite to the permanent magnet 10. In other words, in the present embodiment, the first coil 41 is disposed on a Z2 direction side of the permanent magnet 10, and the second coil 42 is disposed on a Z1 direction side of the permanent magnet 10. In the present embodiment, two coils, e.g., the coils disposed on the respective opposite sides of the permanent magnet 10 are mounted, and thus the produced magnet field is increased. Thereby, vibrations from the magnet holder 20 can be stronger.

Note that other configurations are similar to those in the first embodiment.

### Third Embodiment

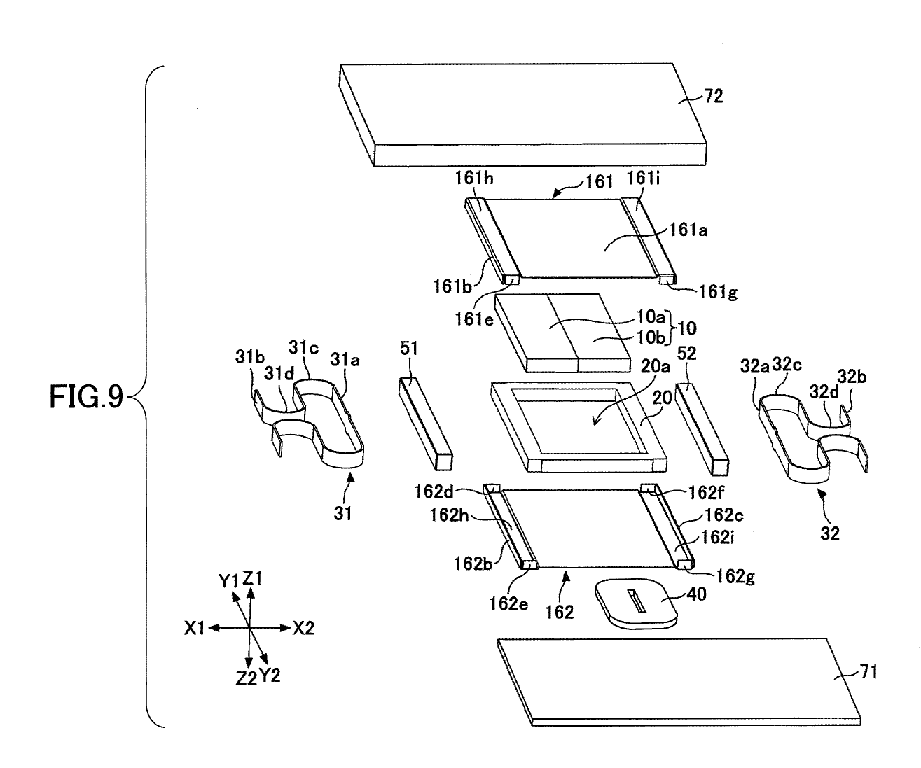

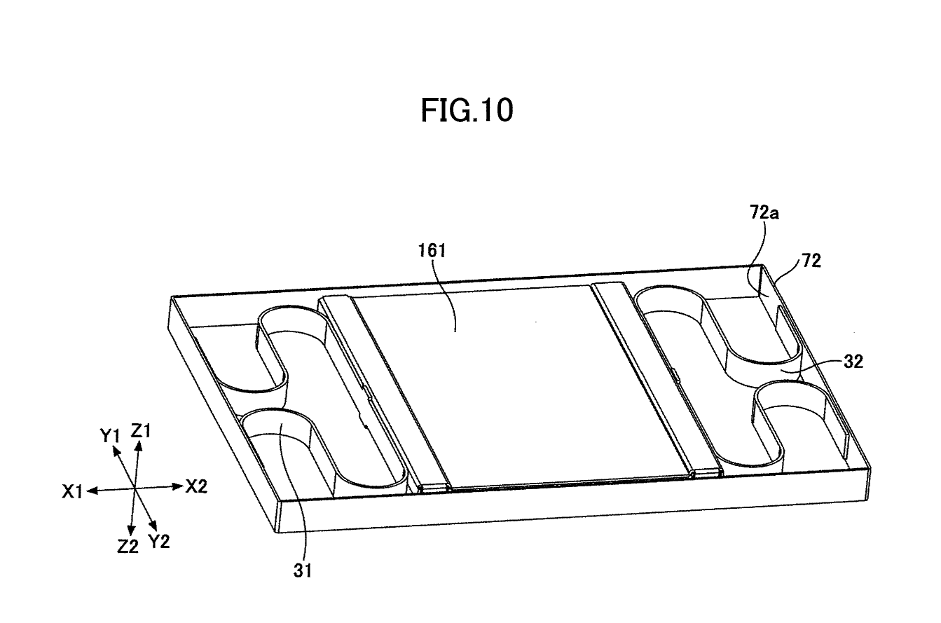

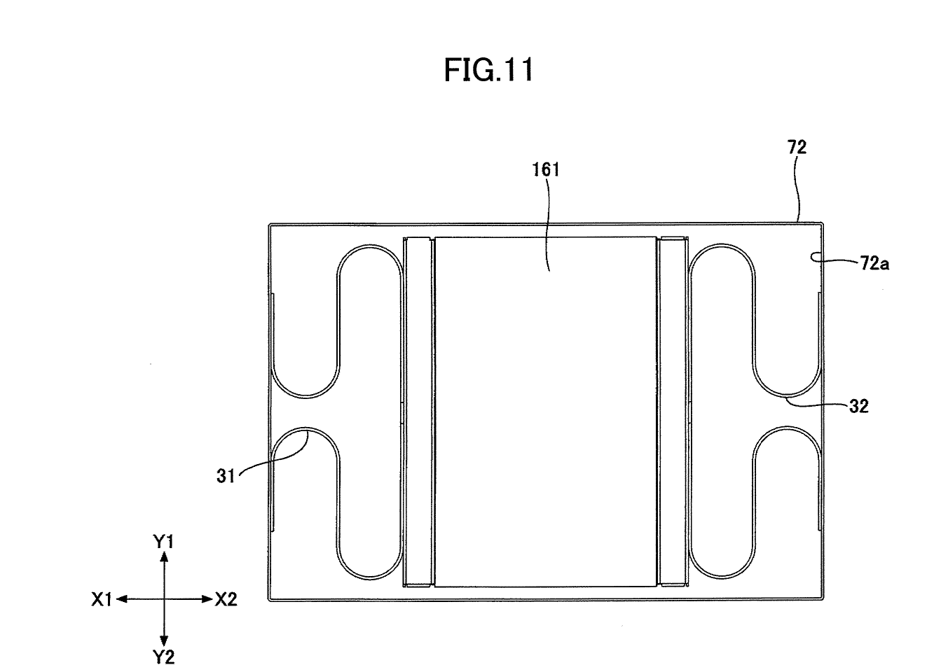

Next, a vibration generating device according to a third embodiment is described in detail with reference to FIGS. 9 to 11. FIG. 9 is an exploded perspective view illustrating a vibration generating device according to the present embodiment. FIG. 10 is a perspective view illustrating an internal configuration of the vibration generating device according to the third embodiment from which a cover section thereof is partially removed. FIG. 11 is a top view of FIG. 10. This vibration generating device includes a permanent magnet 10, a magnet holder 20, a first spring section 31, a second spring section 32, a coil 40, a first weight 51, a second weight 52, a first attachment section 161, a second attachment section 162, and the like. These components are encased in a casing that is formed by a base section 71 and a cover section 72. Note that the magnet holder 20 may be formed of laminated metal plates having respective thru-openings.

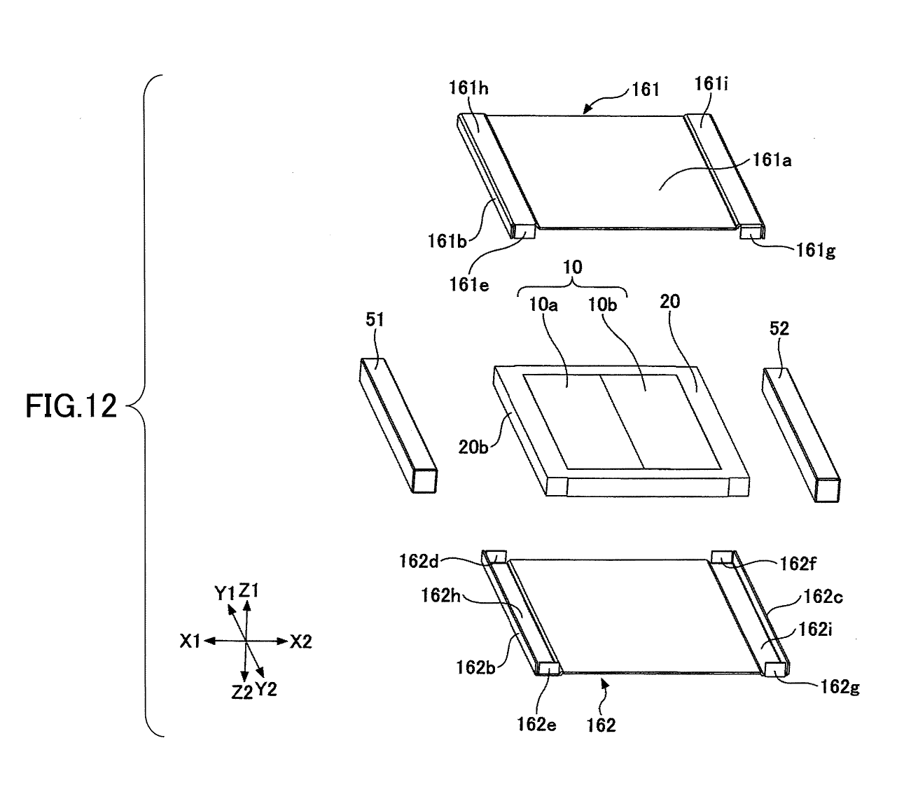

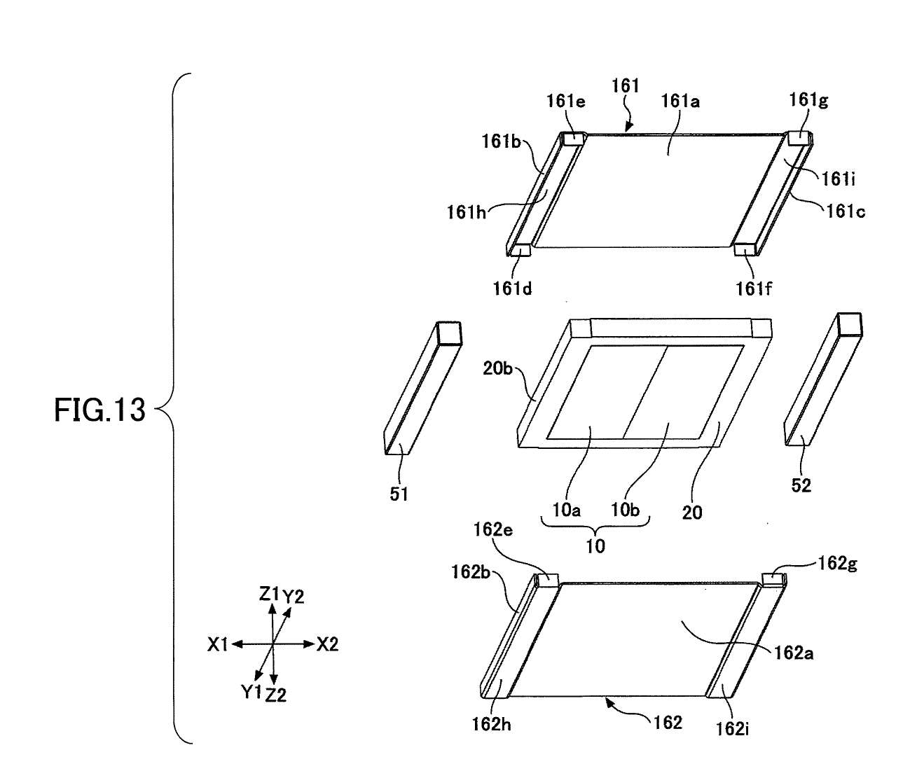

Hereafter, with reference to FIGS. 12 and 13, the first attachment section 161 for attaching the first weight 51 as well as the second attachment section 162 for attaching the second weight 52 are described. Each of the first attachment section 161 and the second attachment section 162 is formed by bending a stainless steel plate. In the present embodiment, each of the first attachment section 161 and the second attachment section 162 is formed by bending a non-magnetic stainless steel plate whose thickness is about 0.2 mm. FIGS. 12 and 13 are perspective views for explaining the first weight 51, the second weight 52, the first attachment section 161 and the second attachment section 162. FIG. 12 is a perspective view of components when viewed from a side of the first attachment section 161. FIG. 13 is a perspective view of components when viewed from a side of the second attachment section 162. The permanent magnet 10 is fixed with an adhesive in a manner in which the permanent magnet 10 is inserted into the opening 20a of the magnet holder 20.

The first attachment section 161 is shaped in an approximate rectangle as a whole, and in end portions of a plate section 161a, which is shaped in an approximate rectangular parallel to an X-Y plane, facing opposite ways along two directions, X-side-weight supporting sections and Y-side-weight supporting sections are formed. In this example, on an X1 direction side of the plate section 161a, an X-side-weight supporting section 161b is formed in a manner such that the X1 direction side of the plate section 161a is bent in a Z2 direction with respect to a Y1-Y2 direction. On an X2 direction side of the plate section 161a, an X-side-weight supporting section 161c is formed in a manner such that the X2 direction side of the plate section 161a is bent in the Z2 direction with respect to the Y1-Y2 direction. On a Y1 direction side of the plate section 161a toward the X1 direction, a Y-side-weight supporting section 161d is formed in a manner such that a Y1 direction side of the plate section 161a is bent in the Z2 direction with respect to an X1-X2 direction. On a Y2 direction side of the plate section 161a toward the X1 direction, a Y-side-weight supporting section 161e is formed in a manner such that a Y2 direction side of the plate section 161a is bent in the Z2 direction with respect to the X1-X2 direction. On a Y2 direction side of the plate section 161a toward the X2 direction, a Y-side-weight supporting section 161g is formed in a manner such that a Y2 direction side of the plate section 161a is bent in the Z2 direction with respect to the X1-X2 direction.

In such a manner, the X-side-weight supporting section 161b and the X-side-weight supporting section 161c are opposite to each other, and are each disposed parallel to a Y-Z plane. Also, the Y-side-weight supporting section 161d and the Y-side-weight supporting section 161e are opposite to each other, and the Y-side-weight supporting section 161f and the Y-side-weight supporting section 161g are opposite to each other. These sections 161d, 161e, 161f and 161g are each disposed parallel to a Z-X plane. Note that, on the X1 direction side of the plate section 161a, a Z-side-weight supporting section 161h may be formed in a manner such that a surface thereof is protruded in the Z1 direction so as to match the shape of the first weight 51. On the X2 direction side of the plate section 161a, a Z-side-weight supporting section 161i may be formed in a manner such that a surface thereof is protruded in the Z1 direction so as to match the shape of the second weight 52.

The second attachment section 162 has a same shape as the first attachment section 161. Specifically, the second attachment section 162 is shaped in an approximate rectangle as a whole, and in end portions of a plate section 162a, which is shaped in an approximate rectangular parallel to an X-Y plane, facing opposite ways along two directions, X-side-weight supporting sections and Y-side-weight supporting sections are famed. In this example, on an X1 direction side of the plate section 162a, an X-side-weight supporting section 162b is formed in a manner such that the X1 direction side of the plate section 162a is bent in the Z1 direction with respect to the Y1-Y2 direction. On an X2 direction side of the plate section 162a, an X-side-weight supporting section 162c is formed in a manner such that the X2 direction side of the plate section 162a is bent in the Z1 direction with respect to the Y1-Y2 direction. On a Y1 direction side of the plate section 162a toward the X1 direction, a Y-side-weight supporting section 162d is formed in a manner such that a Y1 direction side of the plate section 162a is bent in the Z1 direction with respect to an X1-X2 direction. On a Y2 direction side of the plate section 162a toward the X2 direction, a Y-side-weight supporting section 162g is formed in a manner such that a Y2 direction side of the plate section 162a is bent in the Z1 direction with respect to the X1-X2 direction.

In such a manner, the X-side-weight supporting section 162b and the X-side-weight supporting section 162c are opposite to each other, and are each disposed parallel to a Y-Z plane. Also, the Y-side-weight supporting section 162d and the Y-side-weight supporting section 162e are opposite to each other, and the Y-side-weight supporting section 162f and the Y-side-weight supporting section 162g are opposite to each other. These sections 162d, 162e, 162f and 162g are each disposed parallel to a Z-X plane. Note that, on the X1 direction side of the plate section 162a, a Z-side-weight supporting section 162h may be formed in a manner such that a surface thereof is protruded in the Z2 direction so as to match the shape of the first weight 51. On the X2 direction side of the plate section 162a, a Z-side-weight supporting section 162i may be formed in a manner such that a surface thereof is protruded in the Z2 direction so as to match the shape of the second weight 52.

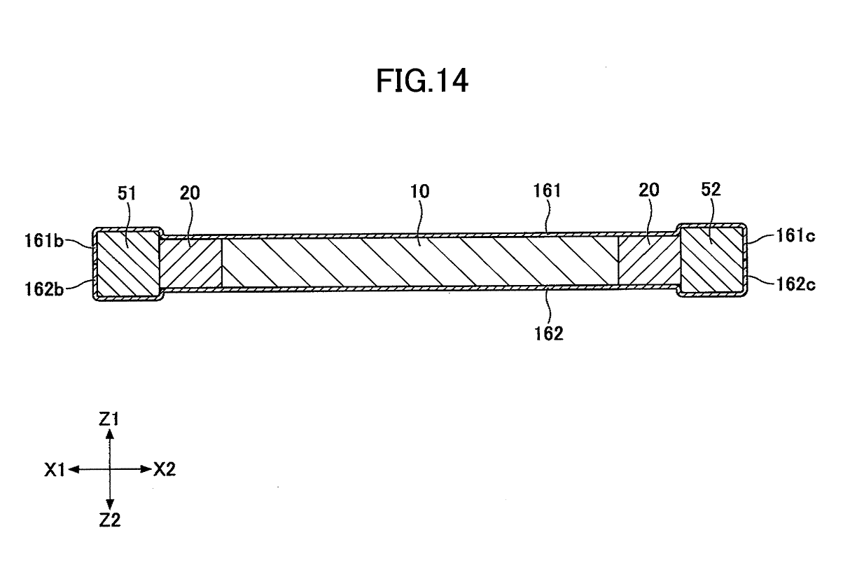

As illustrated in a perspective view in FIG. 14, in the present embodiment, the magnet holder 20, the first weight 51 and the second weight 52 are covered by the first attachment section 161 and the second attachment section 162, and thus are integrated. In this example, on a Z1 direction side of the magnet holder 20 into which the permanent magnet 10 is inserted, the first weight 51 and the second weight 52 are covered by the first attachment section 161, and on a Z2 direction side the magnet holder 20 is covered by the second attachment section 162. These components are joined with an adhesive or the like, and thus are integrated. In the present embodiment, the Z1 direction side of the magnet holder 20 into which the permanent magnet 10 is inserted, the first weight 51 and the second weight 52 may also be referred to as an upper side, and the Z2 direction side of the above components may also be referred to as a lower side.

In such an integrated manner, the Z1 direction side of the magnet holder 20 into which the permanent magnet 10 is inserted, the first weight 51 and the second weight 52 is covered by the plate section 161a of the first attachment section 161, and the Z2 direction side of the above components is covered by the plate section 162a of the second attachment section 162. In the Z1-Z2 direction, the magnet holder 20 into which the permanent magnet 10 is inserted, the first weight 51 and the second weight 52 are sandwiched between the plate section 161a of the first attachment section 161 and the plate section 162a of the second attachment section 162, and are fixed accordingly.

In such a manner, in the X1-X2 direction, the first weight 51 is sandwiched with respect to the magnet holder 20, the X-side-weight supporting section 161b of the first attachment section 161 and the X-side-weight supporting section 162b of the second attachment section 162, and is fixed accordingly. Also, in the Y1-Y2 direction, the first weight 51 is sandwiched with respect to the Y-side-weight supporting sections 161d and 161e of the first attachment section 161 and the Y-side-weight supporting sections 162d and 162e of the second attachment section 162, and is fixed accordingly.

Also, in the X1-X2 direction, the second weight 52 is sandwiched with respect to the magnet holder 20, the X-side-weight supporting section 161c of the first attachment section 161 and the X-side-weight supporting section 162c of the second attachment section 162, and is fixed accordingly. Also, in the Y1-Y2 direction, the second weight 52 is sandwiched with respect to the Y-side-weight supporting sections 161f and 161g of the first attachment section 161 and the Y-side-weight supporting sections 162f and 162g of the second attachment section 162, and is fixed accordingly.

In such a manner, with respect to each of the first weight 51 and the second weight 52 having a cuboid shape whose longitudinal direction is the Y1-Y2 direction, six surfaces thereof are integrally covered by the magnet holder 20, the first attachment section 161, and the second attachment section 162. Thereby, the first weight 51 and the second weight 52 cannot be loosened by a vibration or the like.

In the present embodiment, as illustrated in FIGS. 9 to 11, a first side portion 31a of the first spring section 31 is connected to surfaces on the X1 direction side of the X-side-weight supporting section 161b of the first attachment section 161 and the X-side-weight supporting section 162b of the second attachment section 162, by spot welding. Further, second side portions 31b of the first spring section 31 are each connected to an inner wall surface 72a of the cover section 72 facing the X1 direction, by spot welding. Similarly, a first side portion 32a of the second spring section 32 is connected to surfaces on the X2 direction side of the X-side-weight supporting section 161c of the first attachment section 161 and the X-side-weight supporting section 162c of the second attachment section 162, by spot welding. Further, second side portions 32b of the second spring section 32 are each connected to the inner wall surface 72a of the cover section 72 facing the X2 direction, by spot welding.

In such a manner, the magnet holder 20 into which the permanent magnet 10 is inserted, as well as the first weight 51, the first attachment section 161, the second weight 52 and the second attachment section 162 that are attached to the magnet holder 20, are integrated. These integrated components are sandwiched between the first spring section 31 and the second spring section 32, and thus are positioned floatingly. The flat coil 40 along a plane parallel to the X-Y plane is attached to the base section 71 with an adhesive, such that the coil 40 is situated opposite to the permanent magnet 10 and such that a longitudinal direction of the coil 40 is the Y1-Y2 direction. In the present embodiment, when a current flows into the coil 40, there is an interaction between a produced magnetic field and a magnetic force acting between the pole 10a and the pole 10b of the permanent magnet 10. The interaction can cause the permanent magnet 10 to move in the X1-X2 direction.

In such a manner, a driving force in the X1-X2 direction acting with use of the coil 40 and the permanent magnet 10, as well as an elastic force in the X1-X2 direction acting with use of the first spring section 31 and the second spring section 32, can cause the integrated components, which include the permanent magnet 10, the magnet holder 20, the first weight 51, the second weight 52, the first attachment section 161, and the second attachment section 162, to move in the X1-X2 direction.

Note that each of the first attachment section 161 and the second attachment section 162 may have an opening at a portion facing the permanent magnet 10, and these openings may be continuous with the opening 20a of the magnet holder 20. Further, in a case where the magnet holder 20 is formed of the laminated metal plates having the respective thru-openings, the first attachment section 161, the second attachment section 162 and the magnet holder 20 may be formed of laminated metal plates each having an opening into which the permanent magnet 10 is inserted.

The present embodiments have been described, but are not limited to the examples described above. It will be appreciated by those skilled in the art that modifications, combinations, alternatives to the components of the foregoing embodiments are made within the scope of the present invention or the equivalent thereof.

What is claimed is:

1. A vibration generating device comprising:
at least one coil fixed to a casing;
a permanent holder disposed in the casing;
a permanent magnet attached to the magnet holder, the permanent magnet and the magnet holder being configured to vibrate when a current flows into the coil;
a plurality of elastic supporting sections configured to support the magnet holder;
a plurality of weights formed of material including tungsten; and
a plurality of attachment sections configured to hold the respective weights and be attached to the magnet holder.

2. The vibration generating device according to claim 1, wherein the magnet holder and the permanent magnet vibrate in one direction, and
wherein the weights are attached to respective sides of the magnet holder facing opposite ways along the one direction through the respective attachment sections.

3. The vibration generating device according to claim 1, wherein each of the attachment sections is joined to the magnet holder by welding.

4. The vibration generating device according to claim 1, wherein the magnet holder and the attachment sections are each formed of stainless steel.

5. The vibration generating device according to claim 1, wherein total mass of the weights is heavier than total mass of the magnet holder and the attachment sections.

6. The vibration generating device according to claim 1, wherein each of the supporting sections is a spring, and has a first side portion thereof connected to a corresponding one of the attachment sections and a second side portion thereof connected to an inner surface of the casing.

7. The vibration generating device according to claim 1, wherein the plurality of supporting sections are two supporting sections configured to support the magnet holder at opposite sides thereof,
wherein the plurality of weights are two weights, and
wherein the two weights are held by the respective attachment sections and are attached to the magnet holder.

8. A vibration generating device comprising:
a coil fixed to a casing;
a magnet holder disposed in the casing;
a permanent magnet attached to the magnet holder, the permanent magnet and the magnet holder being configured to vibrate when a current flows into the coil;
a plurality of elastic supporting sections configured to support the magnet holder;
a plurality of weights formed of material including tungsten; and
first and second attachment sections configured to hold the weights and be attached to the magnet holder, wherein an upper side of the magnet holder and the weights is covered by the first attachment section, and a lower side of the magnet holder and the weights is covered by the second attachment section, so that the magnet holder and the weights are integrated.

9. The vibration generating device according to claim 8, wherein the weights are two weights mounted on respective opposite sides of the magnet holder,
wherein the upper side of the magnet holder and the two weights are covered by the upper attachment section, and the lower side of the magnet holder and the two weights is covered by the second attachment section.

10. The vibration generating device according to claim 8, wherein the magnet holder and the permanent magnet vibrate in one direction, and
wherein the weights are attached to respective sides of the magnet holder facing opposite ways along the one direction through the first and second attachment sections.

11. The vibration generating device according to claim 8, wherein the magnet holder and the first and second attachment sections are each formed of stainless steel.

12. The vibration generating device according to claim 8, wherein total mass of the weights is heavier than total mass of the magnet holder and the first and second attachment sections.

13. The vibration generating device according to claim 8, wherein each of the supporting sections is a spring, and has a first side portion thereof connected to a corresponding one of the first and second attachment sections and a second side portion thereof connected to an inner surface of the casing.

14. The vibration generating device according to claim 1, wherein each of the weights is disposed between a corresponding supporting section and the magnet holder.
